(19) United States
(12) Patent Application Publication
(10) Pub. No.: US 2006/0069771 A1
(43) Pub. Date: Mar. 30, 2006

(54) Method, system and program product for decentralized monitoring of server states within a cell of nodes

(75) Inventors: Thomas R. Gissel, Apex, NC (US); Brian K. Martin, Cary, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/953,324

(22) Filed: Sep. 29, 2004

(51) Int. Cl. G06F 15/173

(52) U.S. Cl. 709/224

(57) ABSTRACT

Under the present invention a node agent of a node in a cell will post state (event) information pertaining to the applications server(s) it controls to a messaging service such as a Highly Available (HA) messaging system (e.g., to bulletin board). Also, from the messaging service, the node agent will obtain the identities of other node agents running in the cell. Thereafter, the node agent can establish a direct communication link with those other node agents, and obtain state information pertaining to the application server(s) they control directly therefrom. Alternatively, the node agent can obtain state information for the other node agents directly from the bulletin board.

### BACKGROUND OF THE INVENTION

1. Field of the Invention

In general, the present invention provides a method, system and program product for decentralized monitoring of server states within a cell of nodes. Specifically, the present invention allows states of application servers (and the like) running on nodes within a cell to be monitored by the other nodes without relying on a single point of management such as a node manager.

2. Related Art

As modular programming advances, the use of node cells is rapidly increasing. In a typical node cell arrangement, one or more nodes will be provided. Each node will generally include a node agent and one or more (application) servers. Moreover, in a node cell arrangement, it is common for server state event (e.g., JMX events) information of one node to be made available to other nodes. For example, one node is often made aware of whether an application server on another node is starting, has started, is stopping or has stopped. The current technology is to provide a central node manager to which the individual nodes report their corresponding state information. Should a particular node desire state information pertaining to another node, the particular node will obtain such information directly from the node manager.

An illustration of the existing technology is shown in FIG. 1. As depicted, FIG. 1 shows node cell 10 having nodes 12A-C and node manager 14. Node manager 14 includes deployment manager 20, which oversees and manages node cell 10. Each node 12A-C is shown including node agents 16A-C and application servers 18A-C. Node agents 16A-C generally serve as an intermediary between application servers 18A-C and deployment manager 20. Moreover, administrative logic running in node agents 16A-C keep the configuration data of nodes 12A-C synchronized with the configuration data of the other nodes 12A-C in node cell 10. In general, node agents 16A-C report state information for the applications servers 18A-C they control directly to deployment manager 20. For example, as application servers 18A on node 12A change states, corresponding information will be communicated by node agent 16A to deployment manager 20. Later, should node agent 16C desire to obtain this state information, it will do so by directly communicating with deployment manager 20/node manager 14.

Unfortunately, with such a configuration, there is a single point of failure for node cell 10. Specifically, should node manager 14 or deployment manager 20 fail, there is no way for nodes 12A-C to obtain needed state information. As such, nodes 12A-C will not be able to synchronize with one another. In view of the foregoing, there exists a need for a method, system and program product for decentralized monitoring of server states within a cell of nodes. Specifically, a need exits whereby nodes in a cell can obtain server state information for other nodes directly from the other nodes, or via a decentralized messaging system such as a bulletin board or the like.

### SUMMARY OF THE INVENTION

In general, the present invention provides a method, system and program product for decentralized monitoring of server states within a cell of nodes. Specifically, under the present invention a node agent of a node in the cell will post state (event) information pertaining to the application server(s) it controls to a messaging service such as a Highly Available (HA) messaging system (e.g., to a bulletin board). Also, from the messaging service, the node agent will obtain the identities of other node agents running in the cell. Thereafter, the node agent can establish a direct communication link with those other node agents, and obtain state information pertaining to the application server(s) they control directly therefrom. Alternatively, the node agent can obtain state information for the other node agents directly from the bulletin board.

A first aspect of the present invention provides a method for decentralized monitoring of server states within a cell of nodes, comprising: communicating state information from a first node agent of a first node in the cell to a messaging service, and retrieving an identity of a second node agent running on a second node in the cell from the messaging service to the first node agent; establishing a direct communication link between the first node agent and the second node agent; and obtaining state information from the second node agent to the first node agent through the direct communication link.

A second aspect of the present invention provides a system for decentralized monitoring of server states within a cell of nodes, comprising: a messaging interface system for communicating state information from a first node agent of a first node in the cell to a messaging service, and for retrieving an identity of a second node agent running on a second node in the cell from the messaging service to the first node agent; a node linking system for establishing a direct communication link between the first node agent and the second node agent; and a state information retrieval system for obtaining state information from the second node agent to the first node agent through the direct communication link.

A third aspect of the present invention provides a program product stored on a recordable medium for decentralized monitoring of server states within a cell of nodes, which when executed, comprises: program code for communicating state information from a first node agent of a first node in the cell to a messaging service, and for retrieving an identity of a second node agent running on a second node in the cell from the messaging service to the first node agent; program code for establishing a direct communication link between the first node agent and the second node agent; and program code for obtaining state information from the second node agent to the first node agent through the direct communication link.

A fourth aspect of the present invention provides a computer software embodied in a propagated signal for decentralized monitoring of server states within a cell of nodes, the computer software comprising instructions to cause a computer system to perform the following functions: communicate state information from a first node agent of a first node in the cell to a messaging service, and retrieve an identity of a second node agent running on a second node in the cell from the messaging service to the first node agent; establish a direct communication link between the first node agent and the second node agent; and obtain state information from the second node agent to the first node agent through the direct communication link.

A fifth aspect of the present invention provides a method for deploying an application for decentralized monitoring of server states within a cell of nodes, comprising: providing a computer infrastructure being operable to: communicate state information from a first node agent of a first node in the cell to a messaging service, and retrieve an identity of a second node agent running on a second node in the cell from the messaging service to the first node agent; establish a direct communication link between the first node agent and the second node agent; and obtain state information from the second node agent to the first node agent through the direct communication link.

Therefore, the present invention provides a method, system and program product for decentralized monitoring of server states within a cell of nodes.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for centralized monitoring of server states in a cell of nodes in accordance with the related art.

FIG. 2 depicts a node of a node cell posting associated server state information to a messaging service bulletin board in accordance with the present invention.

FIG. 3 depicts the node of FIG. 2 forming a direct communication link with another node in the cell.

FIG. 4 depicts the nodes of FIG. 3 exchanging server state information.

FIG. 5 depicts a more specific computerized implementation of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience purposes the Detailed Description of the Drawings will have the following sections:

I. General Description

II. Computerized Implementation

I. General Description

As indicated above, the present invention provides a method, system and program product for decentralized monitoring of server states within a cell of nodes. Specifically, under the present invention a node agent of a node in the cell will post state (event) information pertaining to the application server(s) it controls to a messaging service such as a Highly Available (HA) messaging system (e.g., to bulletin board). Also, from the messaging service, the node agent will obtain the identities of other node agents running in the cell. Thereafter, the node agent can establish a direct communication link with those other node agents, and obtain state information pertaining to the application server(s) they control directly therefrom. Alternatively, the node agent can obtain state information for the other node agents directly from the bulletin board. It should be appreciated that although the present invention is typically implemented using and/or based on a HA messaging system and Java Management Extension (JMX) events, this need not be the case. Rather, alternatives could be implemented within the teachings of the present invention.

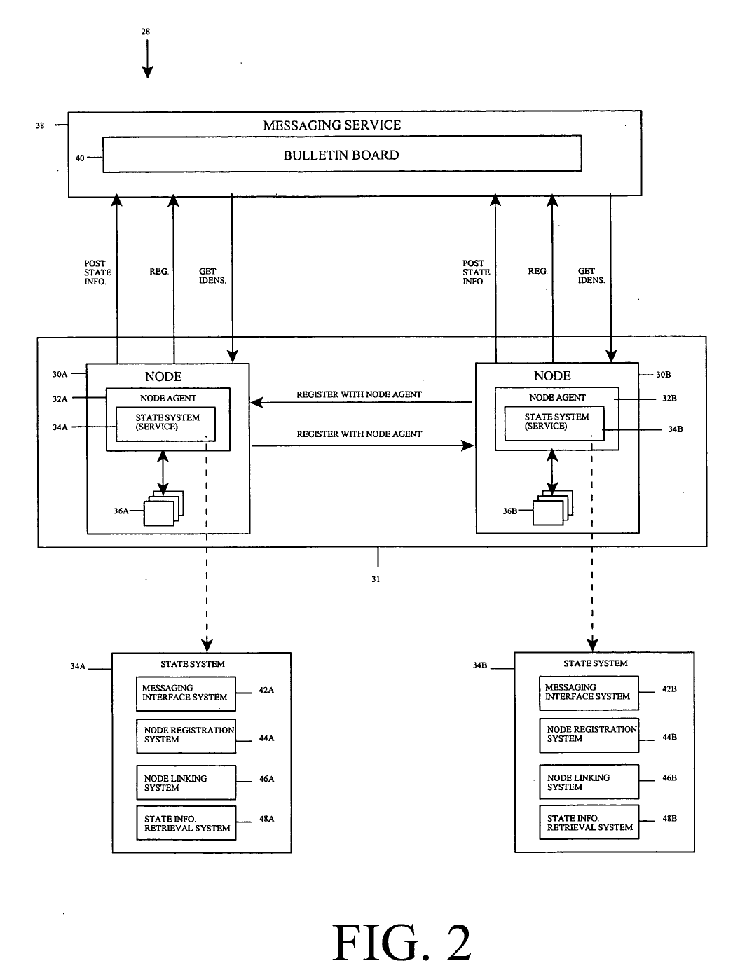

Referring now to FIG. 2, a system 28 for decentralized monitoring of server states in a cell of nodes 31 (hereinafter cell 31) is shown. Specifically, FIG. 2 depicts nodes 30A-B each including at least one node agent 32A-B and one or more application servers 36A-B. It should be understood in advance, however, that two nodes 30A-B are shown for illustrative purposes only and that cell 31 could include any quantity of nodes. In addition, it should be appreciated that nodes 30A-B are intended to represent any type of computerized device capable of carrying out the teachings of the present invention. For example, nodes 30A-B can be desktop computers, laptop computers, hand held devices, clients, servers, etc. In addition, nodes 30A-B are typically connected over a network such as the Internet, a local area network (LAN), a wide area network (WAN), a virtual private network (VPN), etc. Communication throughout the network could occur via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be used. Still yet, connectivity could be provided by conventional IP-based protocol. In this instance, an Internet service provider could be used to establish interconnectivity.

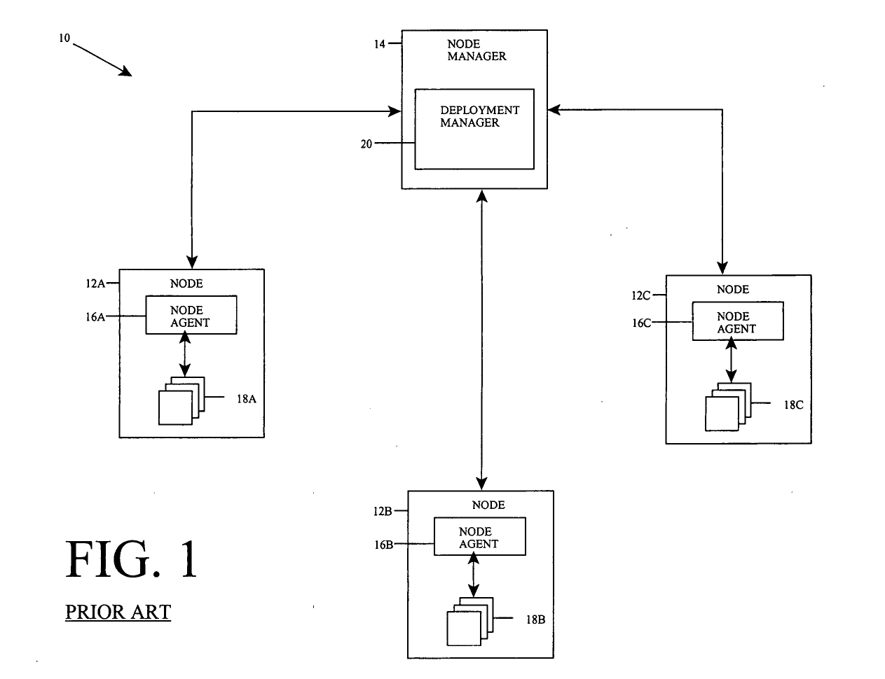

As mentioned above, previous systems required nodes 30A-B to report state information pertaining to their respective application servers 36A-B directly to a node manager (FIG. 1). However, given the single point of failure such a system provides, alternatives were desired. To this extent, under the present invention, each node agent 32A-B is configured with additional program code/logic (shown in FIG. 2 as state systems 34A-B) for providing decentralized monitoring of server state events. In a typical embodiment, state systems 34A-B are realized as “services” (e.g., JAVA services) within node agents 32A-B. However, it should be appreciated that other implementations could exist.

In any event, state systems 34A-B are shown in further detail below nodes 30A-B. As depicted, state systems 34A-B includes messaging interface systems 42A-B, node registration systems 44A-B, node linking systems 46A-B and state information retrieval systems 48A-B. It should be understood that the systems within state systems 34A-B have been depicted as such for illustrative purposes. That is, the underlying functionality of state systems 34A-B could be realized with a different configuration of systems.

In any event, instead of (or in combination with) posting state information to a deployment manager as shown in FIG. 1, nodes 30A-B will post server state information to bulletin board 40 (or a similar medium) associated with messaging service 38 (e.g., a HA messaging service). The type of information posted typically pertains to JMX state events of applications servers 36A-B controlled by node agents 32A-B. Such state events include, among others, a server that is starting, a server that has started, a server that is stopping and as server that has stopped. Accordingly, as state events occur for application servers 36A, messaging interface system 42A will interface with messaging service 38 to post the corresponding information on bulletin board 40. Similarly, as state events occur to application servers 36B, messaging interface system 42A will post the corresponding information on bulletin board 40. It should also be understood that bulletin board 40 is depicted within messaging service 38 for illustrative purposes only. As such, it should be understood that bulletin board 40 can merely be associated with or work in conjunction with messaging service 38.

As an illustrative example, assume that one of the application servers 36A on node 30A has stopped. In such a case, messaging interface system 42A will post information conveying as much on bulletin board 40. While interfacing with messaging service 38, messaging interface system 42A will also register with bulletin board 40 and obtain the identities of any other node agents that are running in cell 31. Thus, if node agent 32B was currently running, it would be identified to node agent 32A (e.g., via messaging interface system 42A). In such a case, the present invention would allow node agent 32A to make a direct communication link with node agent 32B and directly exchange state information therewith. To accomplish this, node registration system 44A will make contact with node agent 32B to register node agent 32A with node agent 32B.

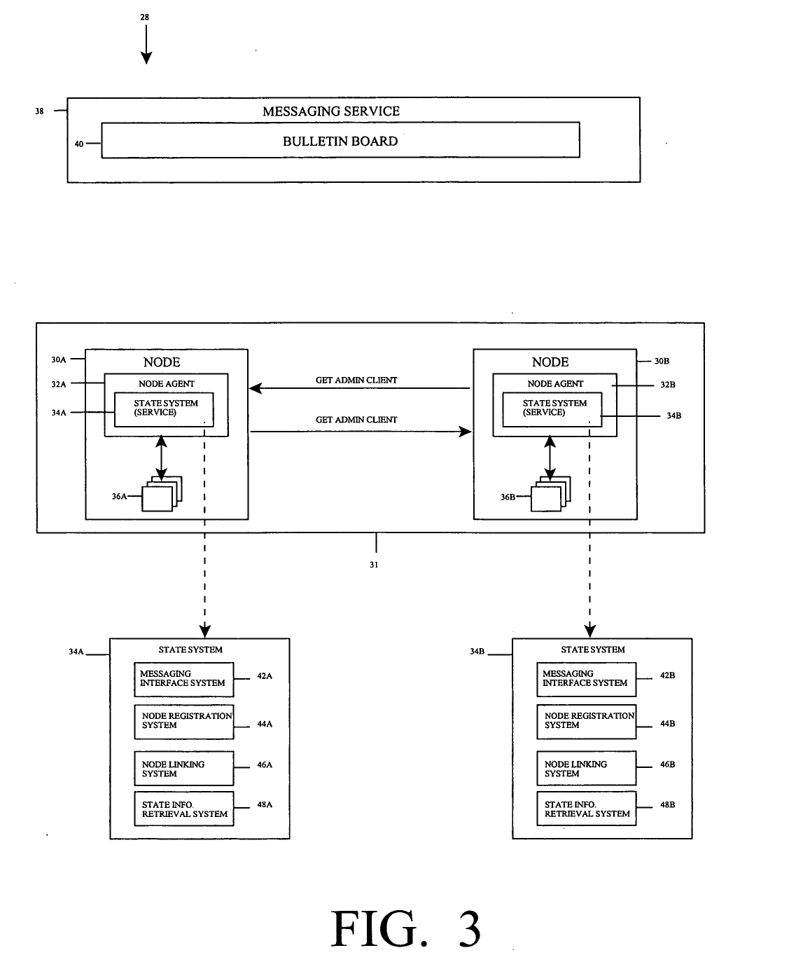

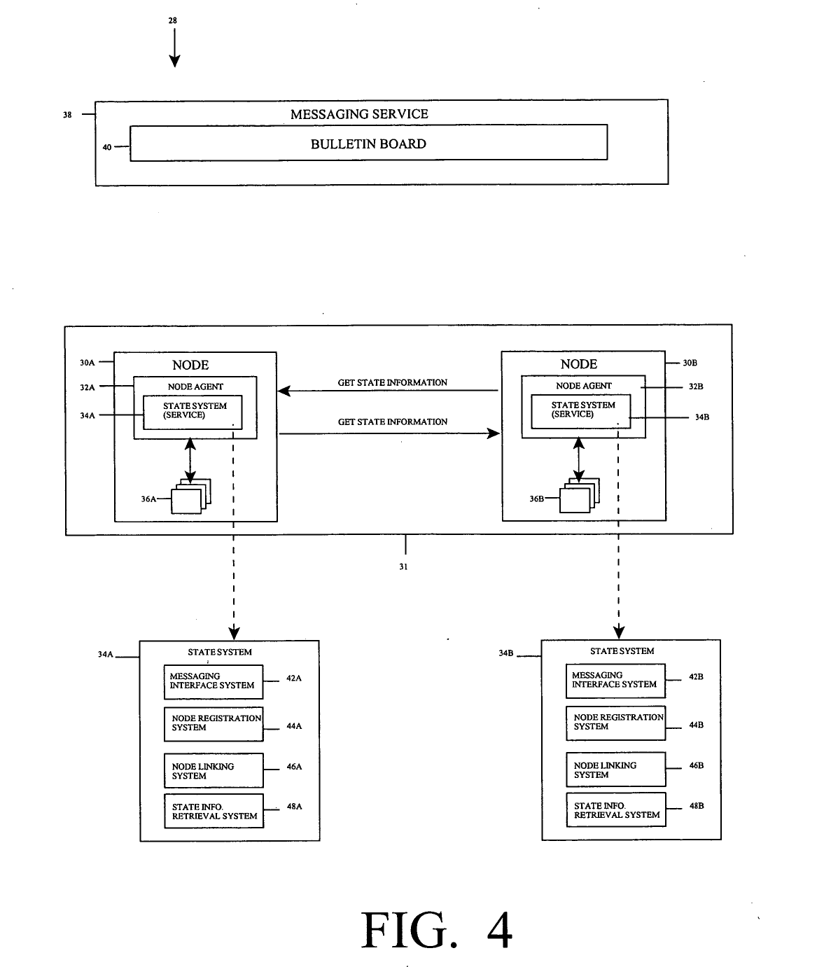

Once registration is complete, node linking system 46A would form a direct connection link with the administrative client of node agent 32B. This is shown in greater detail in FIG. 3. After the direct connection link with the administrative client was formed, state information retrieval system 48A would obtain (e.g., “listen” for JMX state events to occur) server state information directly from node agent 34B through the connection as shown in FIG. 4. At the same time, node registration system 44B within node 30B could register node agent 32B with node agent 32A, node linking system 46B could form a direct connection link with the administrative client of node agent 32A, and state information retrieval system 48A could obtain server state information directly from node agent 32A.

As can be seen, the present invention allow server state information to be obtained directly from the sources, namely, the nodes themselves. This concept applies to a cell having two nodes (such as shown in FIGS. 2-4), or a cell having N nodes. In an alternate embodiment, since state information is posted to bulletin board 40, nodes 30A-B could obtain this information therefrom. This would provide additional redundancy.

II. Computerized Implementation

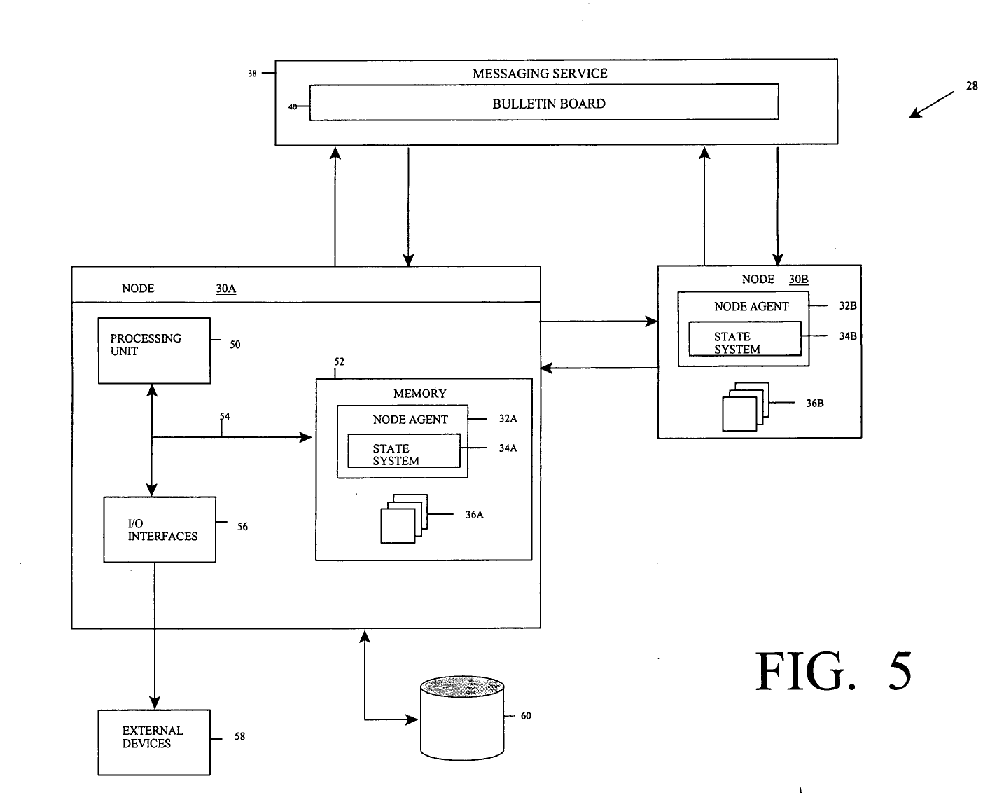

Referring now to FIG. 5, a more specific computerized implementation of the present invention is shown. In FIG. 5, only node 30A has been shown in full form. However, it should be understood that node 30B will include similar components. In any event, node 30A is shown as including processing unit 50, memory 52, bus 54, input/output (I/O) interfaces 56, external devices/resources 58 and storage unit 60. Processing unit 50 may comprise a single processing unit, or be distributed across one or more processing units in one or more locations, e.g., on a client and server. Memory 52 may comprise any known type of data storage and/or transmission media, including magnetic media, optical media, random access memory (RAM), read-only memory (ROM), a data cache, a data object, etc. Moreover, similar to processing unit 50, memory 52 may reside at a single physical location, comprising one or more types of data storage, or be distributed across a plurality of physical systems in various forms.

I/O interfaces 56 may comprise any system for exchanging information to/from an external source. External devices/resources 58 may comprise any known type of external device, including speakers, a CRT, LED screen, hand-held device, keyboard, mouse, voice recognition system, speech output system, printer, monitor/display, facsimile, pager, etc. Bus 54 provides a communication link between each of the components in node 30A and likewise may comprise any known type of transmission link, including electrical, optical, wireless, etc.

Storage unit 60 can be any system (e.g., a database, etc.) capable of providing storage for information (e.g., server state information, etc.) under the present invention. As such, storage unit 60 could include one or more storage devices, such as a magnetic disk drive or an optical disk drive. In another embodiment, storage unit 60 includes data distributed across, for example, a local area network (LAN), wide area network (WAN) or a storage area network (SAN) (not shown). Although not shown, additional components, such as cache memory, communication systems, system software, etc., may be incorporated into node 30A. In addition, as mentioned above, node 30B will have components similar to node 30A. Such components have not been shown for brevity purposes only

Shown in memory 52 of node 30A are node agent 32A, state system 34A and application servers 36A. State systems 34A-B will perform the functions as described above. Specifically, state systems 34A-B will post state information to bulletin board 40, register with bulletin board 40, obtain identities of other running node agents, register with the other running node agents, form a direct communication link with the administrative client of the other running node agents, and obtain server state information directly from the other running node agents.

It should be appreciated that the present invention could be offered as a business method on a subscription or fee basis. For example, nodes 30A-B and/or state systems 34A-B could be created, supported, maintained and/or deployed by a service provider that offers the functions described herein for customers. That is, a service provider could offer to coordinate permission processing for customers.

It should also be understood that the present invention could be realized in hardware, software, a propagated signal, or any combination thereof. Any kind of computer/server system(s)- or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for decentralized monitoring of server states within a cell of nodes, comprising:
communicating state information from a first node agent of a first node in the cell to a messaging service, and retrieving an identity of a second node agent running on a second node in the cell from the messaging service to the first node agent;
establishing a direct communication link between the first node agent and the second node agent; and
obtaining state information from the second node agent to the first node agent through the direct communication link.

2. The method of claim 1, wherein the state information communicated from the first node agent pertains to a state of at least one server managed by the first node agent, and wherein the state information obtained from the second node agent pertains to a state of at least one server managed by the second node agent.

3. The method of claim 1, wherein a service running in the first node agent communicates the state information to the messaging service, establishes the direct communication link with the second node agent, and obtains the state information from the second node agent.

4. The method of claim 1, wherein the establishing step comprises establishing a direct communication link with an administrative client of the second node agent.

5. The method of claim 1, wherein the communicating step comprises posting the state information from the first node agent to a bulletin board associated with the messaging service.

6. The method of claim 1, wherein the messaging service comprises a Highly Available (HA) messaging service.

7. The method of claim 1, further comprising:
registering the first node agent with the messaging service pursuant to the communicating step; and
registering the first node agent with the second node agent prior to establishing the direct communication link.

8. A system for decentralized monitoring of server states within a cell of nodes, comprising:
a messaging interface system for communicating state information from a first node agent of a first node in the cell to a messaging service, and for retrieving an identity of a second node agent running on a second node in the cell from the messaging service to the first node agent;
a node linking system for establishing a direct communication link between the first node agent and the second node agent; and
a state information retrieval system for obtaining state information from the second node agent to the first node agent through the direct communication link.

9. The system of claim 8, wherein the state information communicated from the first node agent pertains to a state of at least one server managed by the first node agent, and wherein the state information obtained from the second node agent pertains to a state of at least one server managed by the second node agent.

10. The system of claim 8, wherein the system comprises a service running in the first node agent.

11. The system of claim 8, wherein the messaging interface system further registers the first node agent with the messaging service.

12. The system of claim 8, further comprising a node registration system for registering the first node agent with the second node agent.

13. The system of claim 8, wherein the node linking system establishes a direct communication link with an administrative client of the second node agent.

14. The system of claim 8, wherein the messaging interface system posts the state information from the first node agent to a bulletin board associated with the messaging service.

15. The system of claim 8, wherein the messaging service comprises a Highly Available (HA) messaging service.

16. A program product stored on a recordable medium for decentralized monitoring of server states within a cell of nodes, which when executed, comprises:
program code for communicating state information from a first node agent of a first node in the cell to a messaging service, and for retrieving an identity of a second node agent running on a second node in the cell from the messaging service to the first node agent;
program code for establishing a direct communication link between the first node agent and the second node agent; and
program code for obtaining state information from the second node agent to the first node agent through the direct communication link.

17. The program product of claim 16, wherein the state information communicated from the first node agent pertains to a state of at least one server managed by the first node agent, and wherein the state information obtained from the second node agent pertains to a state of at least one server managed by the second node agent.

18. The program product of claim 16, wherein the program product is implemented as a service running in the first node agent.

19. The program product of claim 16, further comprising program code for registering the first node agent with the messaging service.

20. The program product of claim 16, further comprising program code for registering the first node agent with the second node agent.

21. The program product of claim 16, wherein the program code for establishing the direct communication link establishes the direct communication link with an administrative client of the second node agent.

22. The program product of claim 16, wherein the program code for communicating posts the state information from the first node agent to a bulletin board associated with the messaging service.

23. The program product of claim 16, wherein the messaging service comprises a Highly Available (HA) messaging service.

24. Computer software embodied in a propagated signal for decentralized monitoring of server states within a cell of nodes, the computer software comprising instructions to cause a computer system to perform the following functions:
communicate state information from a first node agent of a first node in the cell to a messaging service, and retrieving an identity of a second node agent running on a second node in the cell from the messaging service to the first node agent;
establish a direct communication link between the first node agent and the second node agent; and
obtain state information from the second node agent to the first node agent through the direct communication link.

25. A method for deploying an application for decentralized monitoring of server states within a cell of nodes, comprising:
providing a computer infrastructure being operable to:
communicate state information from a first node agent of a first node in the cell to a messaging service, and retrieving an identity of a second node agent running on a second node in the cell from the messaging service to the first node agent;
establish a direct communication link between the first node agent and the second node agent; and
obtain state information from the second node agent to the first node agent through the direct communication link.
